(19) United States
(12) Patent Application Publication
(10) Pub. No.: US 2017/0196195 A1
(43) Pub. Date: Jul. 13, 2017

(54) PET MAT

(71) Applicant: Shane T. Wisdom, Saint Louis, MO (US)

(72) Inventor: Shane T. Wisdom, Saint Louis, MO (US)

(21) Appl. No.: 14/471,925

(22) Filed: Aug. 28, 2014

Related U.S. Application Data
(63) Continuation-in-part of application No. 13/560,512, filed on Jul. 27, 2012, now abandoned.
Application No. 13/560,512 is a continuation-in-part of application No. 13/406,245, filed on Feb. 27, 2012, now abandoned.

(51) Int. Cl. A01K 1/035; A01K 15/02; G08B 25/10; A01K 29/00

(52) U.S. Cl. CPC A01K 1/035; A01K 29/00; A01K 15/021; G08B 25/10

(57) ABSTRACT

A mat system includes a mat having a pressure-sensing switch, and a transmission unit operatively connected to the pressure-sensing switch of the mat via a wired connection. The transmission unit includes a first input module configured to accept a first input, and a first playback module. The first playback module is configured to play the audio that represents the first input upon activation of the pressure-sensing switch. The transmission unit includes a wireless transmitter configured to transmit a wireless signal indicating that the pressure-sensing switch has been activated. The mat system includes a reception unit having a wireless receiver configured to receive the wireless signal from the wireless transmitter. The reception unit includes a second input module configured to accept a second input, and a second playback module. The second playback module is configured so play the audio that represents the second input upon activation of the pressure-sensing switch.

### CROSS-REFERENCE TO RELATED APPLICATIONS

This application claims priority to and is a Continuation-in-Part of U.S. application Ser. No. 13/560,512 (the '512 application), filed on Jul. 27, 2012 and entitled “PET MAT”, which is a Continuation-In-Part of U.S. application Ser. No. 13/406,245 (the '245 application), which was filed an Feb. 27, 2012 and entitled “PET MAT”. The entire subject matter of the '512 application and the entire subject matter of the '245 application are herein incorporated by reference.

### BACKGROUND OF THE INVENTION

The subject mailer described and/or illustrated herein relates generally to a mat system for a pet.

More and more pets are living comfortably inside the dwelling of the pet's owner. For example, many pets remain inside a pet owner's dwelling during the majority of the time that the pet owner is home. As with any animal, pets need to relieve themselves and may need to go outside the dwelling to do so. But, it may be difficult to know when the pet wants to exit the dwelling to relieve themselves, which may result in an accident when the pet owner does not let the pet outside the dwelling in time. Moreover, when the pet is outside the dwelling, it may be difficult to know when the pet wants to come back inside. Accordingly, a pet owner may leave the pet outside in inclement or bad weather, which may cause injury and/or discomfort to the pet.

### BRIEF DESCRIPTION OF THE INVENTION

In an embodiment, a mat system is provided for a pet. The mat system includes a mat having a pet side. The mat is configured to be positioned on a ground surface such that the pet side of the mat is exposed for receiving at least a portion of a pet thereon. The mat includes a pressure-sensing switch configured to be activated when the pet applies a predetermined amount of pressure to the mat. The mat system includes a transmission unit operatively connected to the pressure-sensing switch of the mat via a wired connection. The transmission unit includes a first input module configured to accept a first input from a person, and a first playback module operatively connected to the first input module such that the first playback module is configured to play audio that represents the first input. The first playback module is operatively connected to the pressure-sensing switch via the wired connection between the transmission unit and the mat. The first playback module is configured to play the audio that represents the first input upon activation of the pressure-sensing switch. The transmission unit includes a wireless transmitter operatively connected to the pressure-sensing switch of the mat. The wireless transmitter is configured to transmit a wireless signal indicating dial the pressure-sensing switch has been activated. The mat system includes a reception unit that includes a wireless receiver configured to receive the wireless signal from the wireless transmitter of the transmission unit a second input module configured to accept a second input from a person, and a second playback module operatively connected to the second input module such that the second playback module is configured to play audio that represents the second input. The second playback module is operatively connected to the wireless receiver for receiving the indication that the pressure-sensing switch of the mat has been activated. The second playback module is configured to play the audio that represents the second input upon activation of the pressure-sensing switch.

In an embodiment, a mat system is provided for a pet. The mat system includes a mat having a pet side. The mat is configured to be positioned on a ground surface such that the pet side of the mat is exposed for receiving at least a portion of a pet thereon. The mat includes a pressure-sensing switch configured to be activated when the pet applies a predetermined amount of pressure to the mat. The mat system includes a transmission unit operatively connected to the pressure-sensing switch of the mat via a wired connection. The transmission unit includes a first input module configured to accept a first input from a person, and a first playback module operatively connected to the first input module such that the first playback module is configured to play audio that represents the first input. The first playback module is operatively connected to the pressure-sensing switch via the wired connection between the transmission unit and the mat. The first playback module is configured to play the audio that represents the first input upon activation of the pressure-sensing switch. The transmission unit includes a wireless transmitter operatively connected to the pressure-sensing switch of the mat. The wireless transmitter is configured to transmit a wireless signal indicating that the pressure-sensing switch has been activated. The mat system includes a first reception unit having a first wireless receiver configured to receive the wireless signal from the wireless transmitter of the transmission unit a second input module configured to accept a second input from a person, and a second playback module operatively connected to the second input module such that the second playback module is configured to play audio that represents the second input. The second playback module is operatively connected to the first wireless receiver for receiving the indication that the pressure-sensing switch of the mat has been activated. The second playback module is configured to play the audio that represents the second input upon activation of the pressure-sensing switch. The mat system includes a second reception unit having a second wireless receiver configured to at least one of receive the wireless signal from the wireless transmitter of the transmission unit that indicates that the pressure-sensing switch has been activated or receive a wireless signal that indicates that the pressure-sensing switch has been activated from a second wireless transmitter that is included by the first reception unit. The second reception unit includes a third input module configured to accept a third input from a person, and a third playback module operatively connected to the third input module such that the third playback module is configured to play audio that represents the third input. The third playback module is operatively connected to the second wireless receiver for receiving the indication that the pressure-sensing switch of the mat has been activated. The third playback module is configured to play the audio that represents the third input upon activation of the pressure-sensing switch.

In an embodiment, a mat system is provided for a pet. The mat system includes a first mat having a pet side. The first mat is configured to be positioned on a ground surface such that the pet side of the first mat is exposed for receiving at least a portion of a pet thereon. The first mat includes a first pressure-sensing switch configured to be activated when the pet applies a predetermined amount of pressure to the first mat. The mat system includes a first transmission unit operatively connected to the first pressure-sensing switch of the first mat via a wired connection. The first transmission unit includes a first input module configured to accept a first input from a person, and a first playback module operatively connected to the first input module such that the first playback module is configured to play audio that represents the first input. The first play back module is operatively connected to the first pressure-sensing switch via the wired connection between the first transmission unit and the first mat. The first playback module is configured to play the audio that represents the first input upon activation of the first pressure-sensing switch. The first transmission unit includes a first wireless transmitter operatively connected to the first pressure-sensing switch of the first mat. The first wireless transmitter is configured to transmit a wireless signal indicating that the first pressure-sensing switch has been activated. The mat system includes a second mat having a pet side. The second mat is configured to be positioned on a ground surface such that the pet side of the second mat is exposed for receiving at least a portion of a pet thereon. The second mat includes a second pressure-sensing switch configured to be activated when the pet applies a predetermined amount of pressure to the second mat. The mat system includes a second transmission unit operatively connected to the second pressure-sensing switch of the second mat via a wired connection. The second transmission unit includes a second input module configured to accept a second input from a person, and a second playback module operatively connected to the second input module such that the second playback module is configured to play audio that represents the second input. The second playback module is operatively connected to the second pressure-sensing switch via the wired connection between the second transmission unit and the second mat. The second playback module is configured to play the audio that represents the second input upon activation of the second pressure-sensing switch. The second transmission unit includes a second wireless transmitter operatively connected to the second pressure-sensing switch of the second mat. The second wireless transmitter being configured to transmit a wireless signal indicating that the second pressure-sensing switch has been activated. The mat system includes a reception unit having a wireless receiver configured to receive the wireless signal from the first wireless transmitter of the first transmission unit. The wireless receiver is configured to receive the wireless signal from the second wireless transmitter of the second transmission unit. The reception unit includes a third input module configured to accept a third input from a person, and a third playback module operatively connected to the third input module such that the third playback module is configured to play audio that represents the third input. The third playback module is operatively connected to the wireless receiver for receiving the indication that the first pressure-sensing switch of the first mat has been activated. The third playback module is configured to play the audio that represents the third input upon activation of the first pressure-sensing switch. The third playback module is operatively connected to the wireless receiver for receiving the indication that the second pressure-sensing switch of the second mat has been activated. The third playback module is configured to, upon activation of the second pressure-sensing switch of the second mat, at least one of play the audio that represents the third input or play at least one other audio that represents at least one other input accepted by the third input module of the reception unit.

### BRIEF DESCRIPTION OF THE DRAWINGS

FIG. 1 is a perspective view of an exemplary embodiment of a mat system.

FIG. 2 is a block diagram of the mat system shown in FIG. 1.

FIG. 3 is a flowchart illustrating an exemplary embodiment of a method of using the mat system shown in FIGS. 1 and 2.

FIG. 4 is a perspective view of another exemplary embodiment of a mat system.

FIG. 5 is a block diagram of another exemplary embodiment of a mat system.

FIG. 6 is a block diagram of another exemplary embodiment of a mat system.

FIG. 7 is a block diagram of another exemplary embodiment of a mat system.

FIG. 8 is a block diagram of another exemplary embodiment of a mat system.

FIG. 9 is a block diagram of another exemplary embodiment of a mat system.

FIG. 10 is a block diagram of another exemplary embodiment of a mat system.

### DETAILED DESCRIPTION OF THE INVENTION

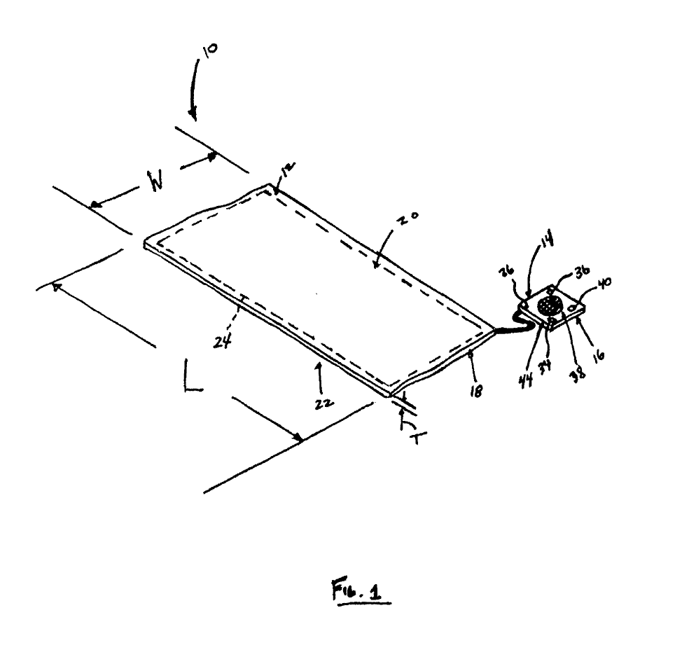

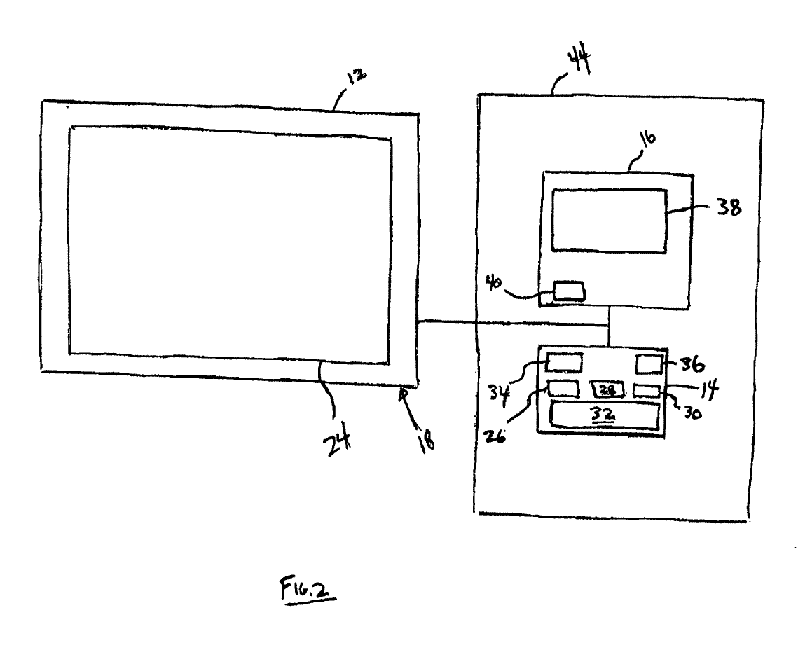

FIG. 1 is a perspective view of an exemplary embodiment of mat system 10. FIG. 2 is a block diagram of the mat system 10. Referring now to FIGS. 1 and 2, the exemplary embodiment of the mat system 10 includes a mat 12, an input module 14, and a playback module 16. As will be described below, the mat system 10 may be used to enable a pet or other individual to enter and/or exit an enclosure (not shown) through a barrier (not shown). For example, the mat system 10 may be used to enable the pet to enter or exit a dwelling through a door. Specifically, when the pet applies pressure to the mat 12, for example by standing or lying on the mat 12, the playback module 16 of the mat system 10 plays an audio message that indicates that the pet desires to enter or exit the enclosure through the barrier. The input module 10 enables a person to select the audio message. For example, the input module 10 may enable the person to record the audio message in the person's own voice. In response to hearing playback of the audio message, a person or other individual can open the barrier to the enclosure to enable the pet to enter or exit the enclosure through the barrier.

The mat 12 includes a body 18 having opposite sides 20 and 22. The side 22 of the mat 12 is configured to be placed on a ground surface such that the side 20 is exposed. The side 20 is configured to receive at least a portion of the pet thereon. For example, the pet may stand on the side 20 of the mat 12 with one or more of the pet's legs, arms, tail, head, nose, and/or other appendages; the pet may tie the pet's torso, core, and/or the like on the side 20; and/or the pet may poke, grab, and/or otherwise engage the side 20 with one or more of the pet's legs, arms, tail, head, nose, and/or other appendages. The side 20 of the mat 12 may be referred to herein as a “pet side”.

In the exemplary embodiment, the approximate entirety of the body 18 of the mat 12 has a relatively sturdy construction, for example a construction that is substantially similar to a wide variety of traditional door mats. But, an approximate entirety of the body 18 may have a relatively soft and/or compliant construction, for example a construction that is substantially similar to a wide variety of traditional pet beds. In other embodiments, the body 18 may include a combination of a relatively sturdy contraction and a relatively soft and/or compliant construction. For example, in some embodiments, the body 18 of the mat 12 has a relatively sturdy construction along the side 22 and a relatively soft and/or compliant construction along the side 20. Another example of a combination construction includes a construction wherein only one or more portions of the surface of the side 20 have a relatively soft and/or compliant construction. Providing a soft and/or compliant surface along one or more portions of the side 20 may provide a more comfortable surface for the pet to stand on, lie on, and/or otherwise engage.

The body 18 of the mat 12 may be formed and/or otherwise fabricated front any material(s) that enable the mat 12 to function as described and/or illustrated herein. In the exemplary embodiment the body 18 has a rectangular shape. But, the body 18 of the mat 12 may have any other shape that enables the mat 12 to function as described and/or illustrated herein. The mat body 18 may have any size that enables the mat 12 to function as described and/or illustrated herein. The thickness T of the body 18 may be selected to provide the amount of softness and/or compliance of the body 18. As used herein, the phrase “ground surface” is intended to mean any surface that enables the mat 12 to function as described and/or illustrated herein, whether such surface is within and/or exterior to the enclosure.

The mat 12 includes a pressure-sensing switch 34 configured to be activated when the pet applies a predetermined amount of pressure to the mat 12. By “activated”, it is meant that the pressure-sensing switch 24 indicates in any manner that the predetermined amount of pressure has been applied to the mat 12. The value of the predetermined amount of pressure may be any value, which may depend on the particular type of pet with which the mat 12 is intended to be used. For example, the value of the predetermined amount of pressure may be based on a size and/or weight of a particular type of pet (e.g., a weight threshold of a particular type of pet). The weight threshold may be used to determine between different types of pets. For example, a pet owner may desire that the pressure-sensing switch 24 is activated when a dog applies pressure to the mat 12 but not when a cat applies pressure to the mat 12. In some embodiments, the value of the predetermined amount of pressure is selectable by a person, for example from a range of the value and/or using the input module 14. Selection of the value of the predetermined amount of pressure may enable a person to select a weight threshold of the person's specific pet. The pet may apply the predetermined pressure to the mat 12 in any manner, for example by standing on the side 20 of the mat 12 with one or more of the pet's legs, arms, tail, head, nose, and/or other appendages; by lying on the side 20 of the mat 12 with the pet's torso, core, and/or the like; and/or by poking, grabbing, and/or otherwise engaging the side 20 with one or more of the pet's legs, arms, tail, head, nose, and/or other appendages.

The pressure-sensing switch 24 may be any type of switch that enables the pressure-sensing switch 24 to function as described and/or illustrated herein. For example, the pressure-sensing switch 24 may be, but is not limited to being, a mechanical switch, an electromechanical switch, an electronic switch, a digital active device, a toggle switch, a relay, a trembler switch, a transistor, a logic gate, a normally-open switch, a normally-closed switch, and/or the like. As can be seen in FIG. 1, in the exemplary embodiment, the pressure-sensing switch 24 extends along a majority of the length L and width W of the mat body 18. But, the pressure-sensing switch 24 may extend along any amount of the length and/or width W of the body 18 of the mat 12 that enables the pressure-sensing switch 24 to sense whether the predetermined amount of pressure has been applied to the body 18 of the mat 12. In some embodiments, the pressure-sensing switch 24 extends along only a minority of the length L and/or width W of the body 18. Moreover, in some embodiments, the mat 12 includes a plurality of pressure-sensing switches 24 spread out at different locations along the length L and/or width W of the mat body 18. As indicated in FIG. 1, in the exemplary embodiment, the pressure-sensing switch 24 is positioned within an interior of the body 18 of the mat 12. But, one or more pressure-sensing switches 24 may alternatively be positioned on an exterior surface of the body 18.

Referring now solely to FIG. 2, the input module 14 of the mat system 10 is configured to accept an input from a person. The input enables a person to select an audio message that will be played by the playback module 16 upon activation of the pressure-sensing switch 24. In the exemplary embodiment, the input module 14 includes a microphone 26 and a recording unit 28. Optionally, the mat system 10 includes a memory 30 and/or a processor 32. In the exemplary embodiment the input module 14 includes the memory 30 and the processor 32. The memory 30 may be used to, for example, store one or snore audio messages. The processor 32 may be used to provide processing functionality for some or all of the functions of the input module 14 and/or other components of the mat system 10. The mat system 10 may include one or more power switches 34 for energizing and de-energizing the electrical components of the mat system 10. In the exemplary embodiment the input module 14 includes the power switch 34. But, any other component of the mat system 10 may additionally or alternatively include the power switch 34.

The microphone 26 is configured to receive, or accept, the input from a person as audio that is spoken by the person. In other words, in the exemplary embodiment a person selects the audio message by speaking the audio message into the microphone 26. The recording unit 28 is configured to record the audio spoken by the person for playback by the playback module 16. Accordingly, in the exemplary embodiment, the audio message is a recording of a person's own voice. A microphone activation switch 36 may be provided by the input module 14 for activating the microphone 26 to receive the audio spoken by the person.

In addition or alternatively to the microphone 26 and/or recording unit 28, the input module 14 may include other components for receiving different types of inputs from a person in addition or alternatively to audio that is spoken by the person. For example, the input module 14 may include, but is not limited to including, a keyboard, a mouse, a track, pad, a stylus, a pointer, a touch screen, a rotary knob, and/or the like. In some embodiments, the input module 14 may enable a person to compose the input, select the input from a menu, and/or select the input from a list of at least two inputs. In other words, the input module 14 may enable a person to compose the audio message, select the audio message from a menu, and/or select the audio message from a list of at least two audio messages. In such embodiments, the playback module 16 may playback the selected audio message using a computer voice, using pre-recorded audio (e.g., a person's voice recorded during manufacture of the mat system 10, a pre-recording of a user of the mat system 10, an animal noise, a mechanical noise, another type of sound), and/or the like. Moreover, in such embodiments, the mat system 10 may include the memory 30 for storing a menu of audio messages, a list of audio message, an audio message that has been composed by a user of the mat system 10, and/or the like.

In the exemplary embodiment, the microphone 28 is a discrete component of the mat system 10 from a speaker 38 of the playback module 16. But, the speaker 38 may alternatively be used as the microphone 28. The recording unit 28 may include any structure, component, device, and/or the like that enables the recording units 28 to record audio spoken by a person, such as, but not limited to, an analog recording device, a digital recording device, an electronic memory, a tape drive, a compact disc drive, an MP3 recording device, and/or the like. In some embodiments, the recording unit 28 and the memory 30 are the same component, the recording unit 28 includes the memory 30, or the memory 30 includes the recording unit 28.

The playback module 16 is operatively connected to the input module 14 and is operatively connected to the pressure-sensing switch 24. Using the speaker 38, the playback module 16 is configured to play audio that represents the input received from a person. Specifically, the playback module 16 is configured to play the selected audio message through the speaker 38 upon activation of the pressure-sensing switch 24. The playback module 16 may include any structure, component device, and/or the like that enables the playback module 16 to play the selected audio message, such as, but not limited to, an analog playback device, a digital playback device, a tape drive, a compact disc drive, an MP3 playback device, and/or the like. The playback module 16 may include a playback switch 40 that, upon activation thereof, causes the playback module 16 to play the selected audio message without the pressure-sensing switch 24 being activated. Optionally, the playback module 16 includes the memory 30, the processor 32, and/or the power switch 34.

The playback module 16 may play the selected audio message through the speaker 38 any number of times upon activation of the pressure-sensing switch 24. In some embodiments, the playback module 16 is configured to repeat playback of the selected audio message a predetermined number of times upon activation of the pressure-sensing switch 24, while in other embodiments the playback module 16 is configured to only play the selected audio message once upon activation of the pressure-sensing switch 24. Moreover, in some embodiments, the playback module 16 is configured to repent playback of the selected audio message until the pressure-sensing switch 24 has been deactivated (i.e., the predetermined amount of pressure is no longer being applied to the mat body 18). The input module 14 may be configured to enable a user of the mat system 10 to select the number of times the playback module 16 plays the selected audio message and/or whether the selected audio message is repeated until the pressure-sensing switch 24 is deactivated.

Optionally, the playback module 16 is operatively connected to a door bell system (not shown) of an enclosure. When operatively connected to a door bell system, the playback module 16 may be configured to play the selected audio message using a speaker (not shown) of the door bell system and/or may be configured to activate a door bell (not shown) of the door bell system upon activation of the pressure-sensing switch 24. The speaker(s) of the door bell system may be used in place of, or in addition to, the speaker 38 of the playback module. In other words, when the playback module 16 is operatively connected to a door bell system, the playback module may or may not include the speaker 38. Moreover, the playback module 16 is optionally operatively connected to a speaker system (not shown) of an enclosure, such as, but not limited to, an intercom system, a stereo system, a theater system, an announcement system (e.g., a traditional PA system), and/or the like. When operatively connected to a speaker system of an enclosure, the playback module 16 may be configured to play the selected audio message using one or more speakers of the speaker system. The speaker(s) of the speaker system of the enclosure may be used in place of, or in addition to, the speaker 38 of the playback module. In other words, when the playback module 16 is operatively connected to the speaker system of an enclosure, the playback module may or may not include the speaker 38.

Referring again to FIGS. 1 and 2, the mat system 10 may include a display (not shown) that facilitates communication between the mat system 10 and a user thereof. The mat system 10 may include one or more user interfaces (not shown; e.g., associated with the display). Such user interfaces may include, but are not limited to, one or more buttons, one or more keys, one or more soft keys, a mouse, a pointer, a stylus, a microphone (e.g., the microphone 26), a track ball, a keyboard, a track pad, a touch screen, one or more touch buttons, and/or the like. The display may be a component of, may be associated with, and/or may be integrated with any other component of the mat system 10, such as, but not limited to, the mat body 18, the input module 14, the playback module 16, and/or the housing 44 (described below). In some embodiments, the mat system 10 includes a log module (not shown) that is operatively connected to the pressure-sensing switch 24. The log module may be configured to log a variety of different variables of the mat system 10, such as, but not limited to, a time of day that the pressure-sensing switch 24 is activated, a frequency of activation of the pressure-sensing switch 24, and/or a duration that the pressure-sensing switch 24 remains activated. The log module may include memory and/or processing components for performing the various functions of the log module. For example, the log module may include the memory 30 and/or the processor 32.

The various electrical components of the mat system 10 may be configured to receive electrical power from any type of power source (not shown), such as, but not limited to, a power distribution grid, a battery, an electrical generator, and/or the like. In the exemplary embodiment, the mat system 10 includes a battery (not shown) that supplies electrical power to the various electrical components of the mat system 10. In some embodiments, the mat system 10 includes a power cord (not shown) that is configured to be plugged into a conventional wall outlet for receiving electrical power therefrom.

The mat body 18, the input module 14, the playback module 16, the pressure-sensing switch 24, the log module, and/or various components thereof may be discrete components from each other and/or may be integrated as one or more common components. For example, the mat system 10 may include a control module that includes one or more components of the mat body 18, the input module 14, the playback module 16, the pressure-sensing switch 24, and/or the log module. Moreover, and for example, one or more components of the input module 14, the playback module 16, and/or the log module may be contained within a common housing that is discrete from the mat body 18 or that is integrated with the mat body 18. In the exemplary embodiment, the input module 14 and the play back module 16 are integrated into a common housing 44 that is a discrete component from the body 18 of the mat 12. Yet another example includes integrating the speaker 38 into the mat body 18.

When two or more components of the mat system 10 are discrete components from each other, the discrete components may be supplied with electrical power from the same electrical power source or from different electrical power sources. For example, a component of the mat system 10 that is discrete from one or more other components of the mat system 10 may have an electrical power source that is dedicated thereto. Moreover, in embodiments wherein at least two discrete components of the mat system 10 are supplied with electrical power from the same power source, the discrete components may be separately electrically connected to the common power source or may share an electrical connection to the common power source. For example, a component of the mat system 10 may be supplied with electrical power through another component of the mat system 10 that is discrete relative thereto.

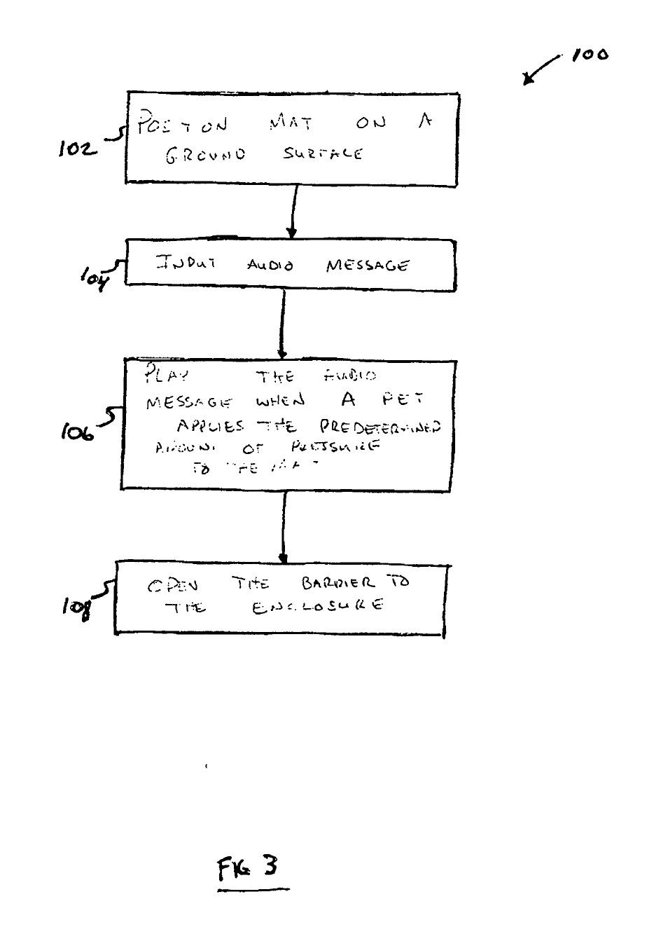

FIG. 3 is a flowchart illustrating an exemplary embodiment of a method 100 of using the mat system 10. The mat system 10 may be used, for example, to enable a pet to enter and/or exit an enclosure through a barrier. The pet may be any type of pet, such as, but not limited to, a dog, a cat, a bird, a hamster, a pig, a reptile, and/or the like. The enclosure may be any type of enclosure, such as, but not limited to, a home, an apartment, a garage, a dwelling, a tent, a cabin, a mobile home, a pet horse, a dorm room, a hotel, a motel, a warehouse, a business, and/or the like. The barrier may be any barrier to exit and/or entry of the enclosure, such as, but not limited to, a door, a window, a pet door, and/or the like.

The method 100 includes positioning 102 the mat 12 on a ground surface such that the side 20 of the mat 12 is exposed for receiving at least a portion of a pet thereon. The mat 12 may be positioned 102 on any ground surface wherein playing of the selected audio message indicates that the pet desires to enter and/or exit the enclosure. The mat 12 may be positioned 102 at a location that is adjacent the barrier, or may be positioned 102 at a location that is remote from the barrier. The mat 12 may be positioned 102 inside the enclosure or outside the enclosure.

At 104, the method 100 includes inputting an audio message using the input module 14. In other words, a user of the mat system 10 selects the audio message that will be played by the playback module 16 upon activation of the pressure-sensing switch 24. As described above, inputting 104 the audio message may include speaking the audio message into the microphone 26, composing the audio message, and/or selecting the audio message from a menu and/or a list.

At 106, the method 100 includes playing the audio message when a pet applies die predetermined amount of pressure to the mat body 18. In other words, the method 100 includes playing 106 the selected audio message upon activation of the pressure-sensing switch 24. The playback 106 of the selected audio message indicates to a person or other individual who hears the audio message that the pet desires to enter or exit the enclosure through the barrier. The method 100 thus further includes opening 108 the barrier to the enclosure in response to hearing the audio message to enable the pet to enter or exit the enclosure.

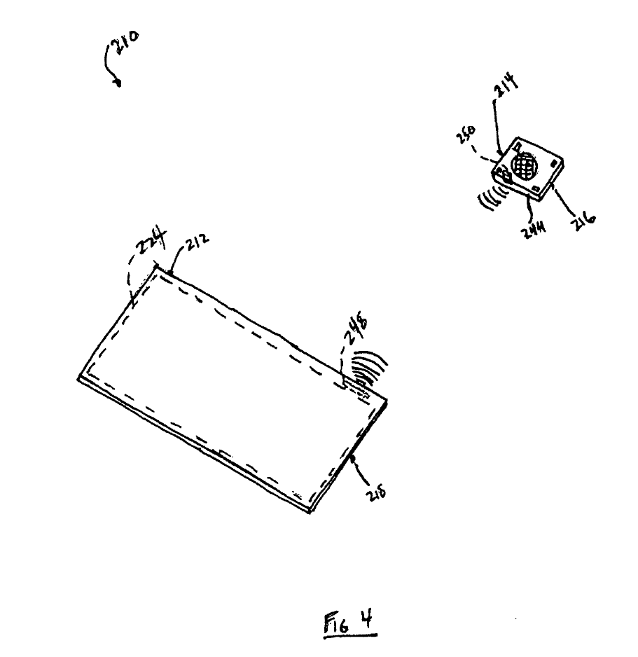

Referring again to FIG. 1, in the exemplary embodiment of the mat system 10, the input module 14 and the playback module 16 are shown as being electrically connected to the mat 12 via an electrical cable 46. But, the mat system 10 is not limited to wired connections. Rather, any component of the mat system 10 may be electrically connected to any other component of the mat system 10 using a wireless connection, such as, but not limited to, using a radio frequency (RF) connection, using a local area network (LAN), using a wide area network (WAN), using a Bluetooth® connection, using a Wi-Fi network, and/or the like. For example, FIG. 4 is a perspective view of another exemplary embodiment of a mat system 210 illustrating one exemplary embodiment of a wireless connection.

The mat system 210 includes a mat 212, an input module 214, and a playback module 216. In the exemplary embodiment of FIG. 4, the input module 214 and the play-back module 216 are integrated into a common housing 244 that is a discrete component from a body 218 of the mat 212. The mat 212 includes a pressure-sensing switch 224 configured to be activated when a predetermined amount of pressure is applied to the mat 212. The playback module 216 is configured to play a selected audio message upon activation of the pressure-sensing switch 224. The mat system 210 may be used so enable a pet or other individual to enter and/or exit an enclosure (not shown) through a barrier (not shown). Excepting for the wireless connection described below, it should be understood that operation of the mat system 210 is substantially similar to operation of the mat system 10.

The mat 212 is electrically connected to the components (e.g., the input module 214 and the play back module 216) of the mat system 210 that are housed by the housing 244 via a wireless connection. For example, the mat 212 includes a transmitter 248 and the mat system 210 includes a receiver 250. The transmitter 248 of the mat 212 is operatively connected to the pressure-sensing switch 224 of the mat 212 such that the transmitter 248 is configured to wirelessly transmit a signal that indicates activation of the pressure-sensing switch 224. In other words, the transmitter 248 is configured to wirelessly transmit a signal that indicates that the predetermined amount of pressure has been applied to the mat 212. The signal transmitted by the transmitter 248 that indicates activation of the pressure-sensing switch 224 will be referred to below as an “activation signal”.

The receiver 250 is configured to wirelessly receive the activation signal from the transmitter 248. The receiver 250 is operatively connected to the playback module 216 for relaying the activation signal to the playback module 216. Upon receiving the activation signal from the receiver 250, the playback module 216 plays the selected audio message (e.g., as is described above with respect to the mat system 10). The transmitter 248 and the receiver 250 may communicate wirelessly using any type of wireless connection, such as, but not limited to, using an RF connection, using a LAN, using a WAN, using the Internet, using a Bluetooth® connection, using a Wi-Fi network, and/or the like.

The transmitter 248 may have any location on, along, and/or within a body 218 of the mat 212. In some embodiments, the mat 212 includes a receiver (not shown) that is configured to wirelessly communicate with a transmitter (not shown) associated with one or more other components (e.g., the input module 214 and/or the playback module 216) of the mat system 210. For example, the transmitter 248 may be a transceiver that includes both wireless transmit and wireless receive functionalities, and/or the mat 212 may include a wireless receiver that is discrete from the transmitter 248.

The receiver 250 may be associated with, may be integrated with, and/or may be a component of any other component of the mat system 210, such as, but not limited to, the input module 214, the playback module 216, and/or the housing 244. In some embodiments, the mat system 210 includes a transmitter (not shown) that is configured to wirelessly communicate with a receiver of the mat 212. For example, the receiver 250 may be a transceiver that includes both wireless transmit and wireless receive functionalities, and/or the mat system 210 may include a wireless transmitter that wirelessly communicates with a receiver of the mat 212 and is discrete from the receiver 250.

Although the embodiments of mat systems described above (e.g., the mat system 10 shown in FIGS. 1 and 2, and the mat system 210 shown in FIG. 4) are shown as including only a single mat (e.g., the mat 12 and the mat 212) and are shown as including only a single speaker (e.g., the speaker 38), the mat systems described and/or illustrated herein are not limited thereto. Rather, the mat systems described and/or illustrated herein may include any number of mats and may include any number of speakers. For example, the mat systems described and/or illustrated herein may include both a plurality of mats and a plurality of speakers. Further, and for example, the mat systems described and/or illustrated herein may include a single mat that is associated with a plurality of speakers, wherein one or more selected audio messages is played through each of the speakers when a predetermined amount of pressure is applied to the mat. Moreover, and for example, the mat systems described and/or illustrated herein may include a plurality of mats that are associated with a single speaker, wherein one or more selected audio messages (which may or may not correspond to the particular mat having the predetermined amount of pressure applied thereto) is played through the speaker when a predetermined amount of pressure is applied to one or more of the mats.

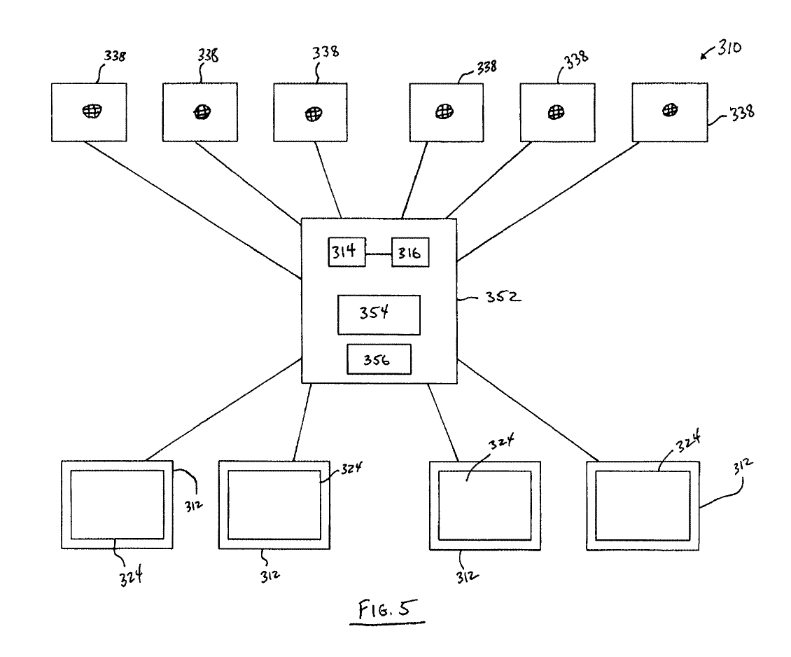

FIG. 5 is a block diagram of another exemplary embodiment of a mat system 310. The mat system 310 includes a central control unit 352, a plurality of mats 312, and a plurality of speakers 338. The mat system 310 may be used to enable a pet or other individual to enter and/or exit an enclosure (not shown) through a barrier (not shown). The mats 312 and the speakers 338 may be located at various different locations within and/or exterior to the enclosure.

Each mat 312 includes a pressure-sensing switch 324 configured to be activated when a predetermined amount of pressure is applied to the mat 312. The central control unit 352 includes an input module 314 and a playback module 316. The central control unit 352 is operatively connected to each of the mats 312 and to each of the speakers 338. The central control unit 352 may be operatively connected to each of the various other components (e.g., the mats 312 and the speakers 338) using a wired and/or a wireless connection. Although four mats 312 are shown, the mat system 310 may include any number of the mats 312. Moreover, although six are shown, the mat system 310 may include any number of the speakers 338. The mat system 310 may include any number of the central control units 352.

When the predetermined amount of pressure is applied to a mat 312, the playback module 316 of the central control unit 352 is configured to play a selected audio message. In other words, the playback module 316 of the central control unit 352 is configured to play one or more selected audio messages upon activation of the pressure-sensing switch 324 of one or more of the mats 312. The audio message that has been selected by the user may be the same for each mat 312, or the user may select audio messages that are associated with corresponding subsets of the mats 312. For example, the same audio message may be assigned to all of the mats 312 such that the same audio message is played by the playback module 316 when the pressure-sensing switch 324 of any of the mats 312 is activated. Moreover, and for example, different audio messages may be assigned to different mats 312 such that different audio messages are played by the playback module 316 when the pressure-sensing switches 324 of different mats 312 are activated. In other words, a particular audio message may be assigned to a particular subset of the mats 312 such that the particular audio message is only played by the playback module 316 when the pressure-sensing switch 324 of one or more of the mats 312 within the particular subset is activated. Each subset of mats 312 may include any number of the mats 312, including only a single mat 312. In some embodiments, each mat 312 is associated with a different audio message from each other mat 312. The input module 314 and/or the playback module 310 of the central control unit 352 may enable a user to assign various audio messages to various mats 312. Moreover, the input module 314 and/or the playback module 316 of the central control unit 352 may store various assignments of audio messages to mats 312.

Each mat 312 may be assigned to any of the speakers 338. Moreover, each mat 312 may be assigned to any number of the speakers 338. For example, each mat 312 may be assigned to all of the speakers 338 such that when the pressure-sensing switch 324 of a particular mat 312 is activated, the selected audio message for the particular mat 312 is played through all of the speakers 338. Moreover, and for example, one or more mats 312 may be assigned to a subset of the speakers 338 such that when the pressure-sensing switch 324 of a particular mat 312 is activated, the selected audio message for the particular mat 312 is only played through the subset of speakers 338 to which the particular mat 312 is assigned. Each subset of speakers 338 may include any number of the speakers 338, including only a single speaker 338. In some embodiments, each mat 312 is assigned to a different single speaker 338 than each other mat 312. The input module 314 and/or the playback module 316 of the central control unit 352 may enable a user to assign various mats 312 to various speakers 338. Moreover, the input module 314 and/or the playback module 316 of the central control unit 352 may store various assignments of mats 312 to speakers 338.

Any components of the mat system 310 may be integrated as components of the central control unit 352. In the exemplary embodiment, the input module 314 and the playback module 316 are integrated as components of the central control unit 352. In other embodiments, the central control unit 352 does not include the input module 314 and/or the playback module 316. For example, one or more mats 312 and/or one or more other locations within and/or exterior to the enclosure may include an input module 314 and/or a playback module 316 that is associated with one or more of the mats 312 and/or one or more of the speakers 338. In some embodiments, the central control unit 352 includes one or all of the speakers 338 of the mat system 310.

The central control unit 352 may include a display 354 that facilitates communication between the mat system 310 and a user thereof. The mat system 310 may include one or more user interfaces 356 (e.g., associated with the display). The user interface 356 may include, but is not limited to, one or more buttons, one or more keys, one or more soft keys, a mouse, a pointer, a stylus, a microphone, a track ball, a keyboard, a track pad, a touch screen, one or more touch buttons, and/or the like. In addition or alternatively to the central control unit 352, the display 354 and/or the user interface 356 may be a component of, may be associated with, and/or may be integrated with any other component of the mat system 310, such as, but not limited to, one or more of the mats 312. In some embodiments, the central control unit 352 and/or one or more other components of the mat system 310 includes a log module (not shown), for example a log module that is substantially similar to the log module described above with respect to the mat system 10.

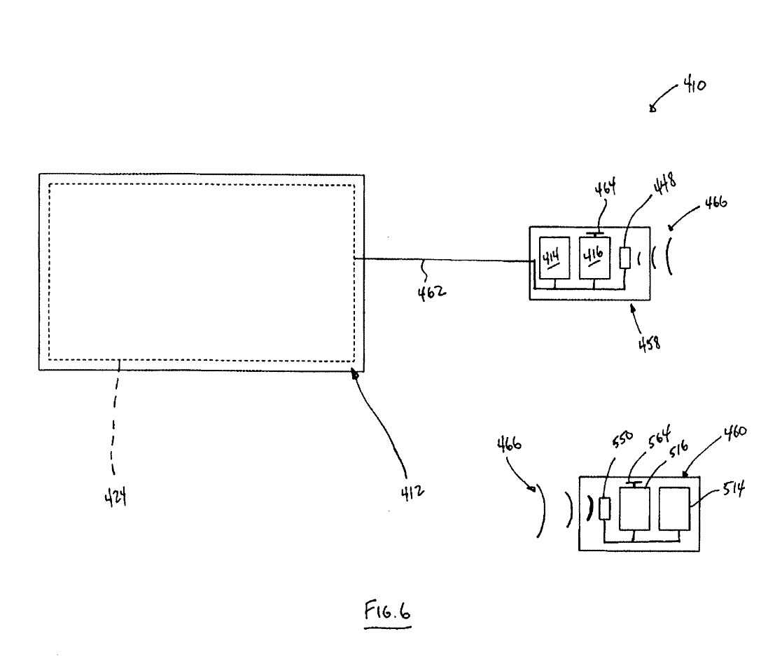

FIG. 6 is a block diagram of another exemplary embodiment of a mat system 410. The mat system 410 includes a mat 412, a transmission unit 458, and a reception unit 460. The mat 412 includes a pressure-sensing switch 424 configured to be activated when a predetermined amount of pressure is applied to the mat 412. The transmission unit 458 is operatively connected to the pressure-sensing switch 424 of the mat 412 via a wired connection 462. The wired connection 462 may be provided by any suitable electrically and/or optically conductive structure that is configured to conduct, convey, transmit, transfer, and/or the like electrical and/or optical energy along a contained path (i.e., not wirelessly through the atmosphere), such as, but not limited to, one or more cables, wires, strands, fibers, bundles, and/or the like. The mat system 410 may be used to enable a pet or other individual to enter and/or exit an enclosure (not shown) through a barrier (not shown). The mat 412 may be referred to herein as a “first” and/or a “second” mat. The transmission unit 458 may be referred to herein as a “first” and/or a “second” transmission unit. The reception unit 460 may be referred to herein as a “first” and/or a “second” reception unit.

The transmission unit 458 includes an input module 414, a playback module 410, and a wireless transmitter 448. The input module 414 is configured to accept an input from a person. The input enables a person to select an audio message that may be played by the playback module 416 upon activation of the pressure-sensing switch 424 of the mat 412. The input module 414 may accept any number of audio messages. The input module 414 may be referred to herein as a “first”, “second”, “third”, and/or “fourth” input module. Any inputs (i.e., audio messages) accepted by the input module 414 may be referred to herein us a “first”, “second”, “third”, and/or “fourth” input.

The playback module 416 is operatively connected to the input module 414 such that the playback module 416 is configured to play a selected audio message previously accepted by the input module 414. The playback module 416 is operatively connected to the pressure-sensing switch 424 of the mat 412 via the wired connection 462 between the transmission unit 458 and the mat 412. The playback module 416 is configured to play the selected audio message upon activation of the pressure-sensing switch 424 of the mat 412. Specifically, upon receiving an activation signal that indicates activation of the pressure-sensing switch 424 of the mat 412, the playback module 416 plays the selected audio message (e.g., as is described above with respect to the mat system 10). The playback module 416 may be configured to play any number of audio messages. The transmission unit 458 may store any number of audio messages. Optionally, the transmission unit 458 includes one or more selector switches 464 and/or other input devices that is operatively connected to the input module 414 and/or the playback module 416 for selecting between recording different audio messages of the transmission unit 458 and/or selecting between playing different audio messages of the transmission unit 458. The playback module 416 may be referred to herein as a “first”, “second”, “third”, and/or “fourth” playback module.

As will be described below, the transmission unit 458 is configured to communicate with (i.e., be operatively connected to) the reception unit 460 using a wireless connection 466. Specifically, the transmission unit 458 includes the wireless transmitter 448 and the reception unit 466 includes a wireless receiver 550 (described below). The wireless connection 466 may be any type of wireless connection, such as, but not limited to, an RF connection, a LAN, a WAN, a Bluetooth® connection, a Wi-Fi network, and/or the like. The wireless transmitter 448 may be referred to herein as a “first” and/or a “second” wireless transmitter.

The wireless transmitter 448 of the transmission unit 458 is operatively connected to the pressure-sensing switch 424 of the mat 412 via the wired connection 462. The wireless transmitter 448 is configured to wirelessly transmit a wireless signal that indicates activation of the pressure-sensing switch 424 of the mat 412. In other words, the wireless transmitter 448 is configured to wirelessly transmit an activation signal that indicates that a predetermined amount of pressure has been applied to the mat 412.

The wireless transmitter 448 may be any type of wireless transmitter that is capable of communicating wirelessly with the reception unit 460. In some embodiments, the wireless transmitter 448 is a transceiver that includes both wireless transmit and wireless receive functionalities, and/or the transmission unit 458 may include a wireless receiver (not shown) that is discrete from the wireless transmitter 448.

Although shown as being operatively connected to the pressure-sensing switch 424 of the mat 412 in parallel, each of the input module 414, the playback module 416, and the wireless transmitter 448 may be operatively connected to the pressure-sensing switch 424 in any other configuration, arrangement and/or pattern relative to each other and/or to the pressure-sensing switch 424. For example, two or more of the input module 414, the playback module 416, and the wireless transmitter 448 may be operatively connected to the pressure-sensing switch 424 in series, and/or two or more of the input module 414, the playback module 416, and the wireless transmitter 448 may be operatively connected to the pressure-sensing switch 424 separately from each other.

In the exemplary embodiment of FIG. 6, the input module 414, the playback module 416, and the wireless transmitter 448 are integrated into a common housing that is a discrete component from a body 418 of the mat 412. Alternatively, one or more components of the transmission unit 458 (e.g., the input module 414, the playback module 416, and/or the wireless transmitter 448) or the transmission unit 458 as a whole may be integrated with the body of the mat 412.

The reception unit 460 includes an input module 514, a playback module 516, and a wireless receiver 550. The input module 514 is configured to accept an input from a person. The input enables a person to select an audio message that may be played by the playback module 516 upon activation of the pressure-sensing switch 424 of the mat 412. The input module 514 may accept any number of audio messages. The input module 514 may be referred to herein as a “first”, “second”, “third”, and/or “fourth” input module. Any inputs (i.e., audio messages) accepted by the input module 514 may be referred to herein as a “first”, “second”, “third”, and/or “fourth” input.

The wireless receiver 550 of the reception unit 460 is operatively connected to the pressure-sensing switch 424 of the mat 412 via the wireless connection 466 between the wireless receiver 550 and the wireless transmitter 448 of the transmission unit 458. Specifically, the wireless receiver 550 is configured to receive the wireless signal that indicates activation of the pressure-sensing switch 424 from the wireless transmitter 448.

The wireless receiver 550 may be any type of wireless receiver 550 that is capable of communicating wirelessly with the transmission unit 458. In some embodiments, the wireless receiver 550 is a transceiver that includes both wireless receive and wireless transmit functionalities, and/or the reception unit 460 may include a wireless transmitter (not shown) that is discrete from the wireless receiver 550.

The playback module 516 is operatively connected to the input module 514 such that the playback module 516 is configured to play a selected audio message previously accepted by the input module 514. The playback module 516 is operatively connected to the wireless receiver 550 for receiving the indication that the pressure-sensing switch 424 of the mat 412 has been activated. The playback module 516 is configured to play the selected audio message upon activation of the pressure-sensing switch 424 of the mat 412. Specifically, upon receiving the indication that the pressure-sensing switch 424 has been activated, the playback module 516 plays the selected audio message (e.g., as is described above with respect to the mat system 10). The playback module 516 may be configured to play any number of audio messages. The reception unit 460 may store any number of audio messages. The playback module 516 may be referred to herein as a “first”, “second”, and/or “fourth” playback module.

Optionally, the reception unit 460 includes one or more selector switches 564 and/or other input devices that is operatively connected to the input module 514 and/or the playback module 516 for selecting between recording different audio messages of the reception unit 460 and/or selecting between playing different audio messages of the reception unit 460.

Although shown as being operatively connected in parallel, each of the input module 514, the playback module 516, and the wireless receiver 550 may be operatively connected to each other in any other configuration, arrangement, and/or pattern relative to each other. For example, two or more of the input module 514, the playback module 516, and the wireless receiver 550 may be operatively connected to each other in series, and/or two or more of the input module 514, the playback module 516, and the wireless receiver 550 may be operatively connected to each other separately.

Optionally, the transmission unit 458 includes one or more selector switches and/or other input devices (not shown) that is configured to selectively prevent the transmission unit 458 or the reception unit 460 from playing audio upon activation of the pressure-sensing switch 424 of the mat 412. In other words, the transmission unit 458 optionally includes one or more selector switches and/or other input device that is configured to enable a user to select to play audio upon activation of the pressure-sensing switch 424: (1) from only the transmission unit 458; (2) from only the reception unit 460; and/or (3) from both the transmission unit 458 and the reception unit 460. Such a selector switch and/or other input device enables the reception mat 460 to be selectively disconnected from the mat 412 such that the playback module 516 of the reception unit 460 does not play audio upon activation of the pressure-sensing switch 424 of the mat 412.

The reception unit 460 optionally includes one or more selector switches and/or other input devices (not shown) that is configured to selectively disconnect the reception unit 460 from the mat 412 such that the playback module 516 of the reception unit 460 does not play audio upon activation of the pressure-sensing switch 424 of the mat 412.

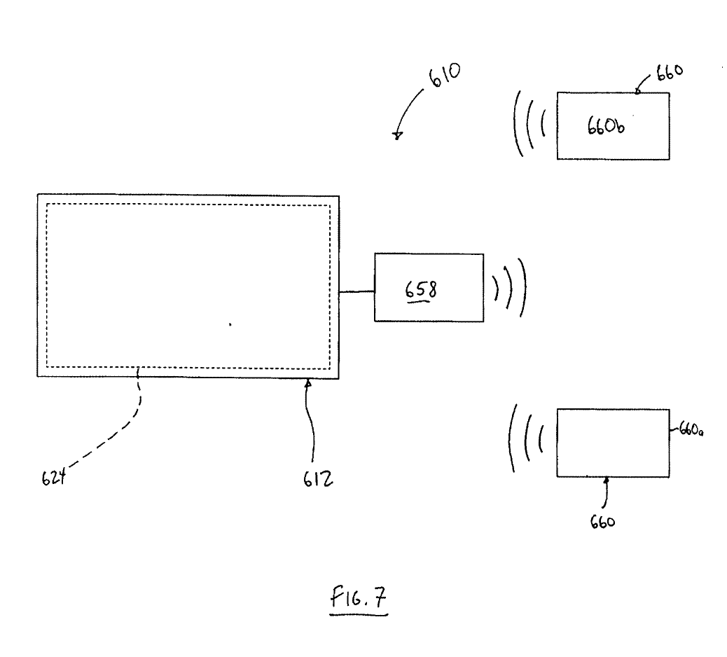

Although the mat system 410 is shown as including only a single reception unit 460 and only a single mat 412 and wired transmission unit 458 pair, the mat system 410 may include any number reception units 460 and any number of mat 412 and wired transmission unit 458 pairs. Rather, the mat system 410 may include any number of reception units 460 and any number of mat 412 and wired transmission unit 458 pairs. For example, FIG. 7 is a block diagram of another exemplary embodiment of a mat system 610. In the exemplary embodiment, the mat system 610 includes two reception units 660a and 660b and a single pair of a mat 612 and a wired transmission unit 658. The mat system 610 may include any number of reception units 660 and any number of mat 612 and wired transmission unit 658 pairs. The mat 612 may be referred to herein as a “first” and/or a “second” mat. The transmission unit 658 may be referred to herein as a “first” and/or a “second” transmission unit. Each reception unit 660a and 660b may be referred to herein as a “first” and/or a “second” reception unit.

Each reception unit 660a and 660b is configured to receive a wireless signal from the transmission unit 658 that indicates that a pressure-sensing switch 624 of the mat 612 has been activated. Each reception unit 660a and 660b is configured to play a selected audio message upon activation of the pressure-sensing switch 624 of the mat 612. Specifically, upon wirelessly receiving the indication that the pressure-sensing switch 624 has been activated, each reception unit 660a and 660b plays the corresponding selected audio message (e.g., as is described above with respect to the mat system 10).

Optionally, the transmission unit 658 includes one or more selector switches and/or other input devices (not shown) that is configured to enable a user to select to play audio upon activation of the pressure-sensing switch 624 of the mat 612: (1) from only the transmission unit 658; (2) from only the reception unit 660a; (3) from only the reception unit 660b; (4) from any combination of two or more of the transmission unit 658, the reception unit 660a, and the reception unit 660b; and/or (5) from each of the transmission unit 658, the reception unit 660a, and the reception unit 660b. Such a selector switch and/or other input device enables each of the reception units 660a and 660b to be selectively disconnected from the mat 612 such that the reception unit 660 does not play audio upon activation of the pressure-sensing switch 624 of the mat 612.

Each reception unit 660a and 660b optionally includes one or more selector switches and/or other input device (not shown) that is configured to selectively disconnect the reception unit 660 from the mat 612 such that the reception unit 660 does not play audio upon activation of the pressure-sensing switch 624 of the mat 612.

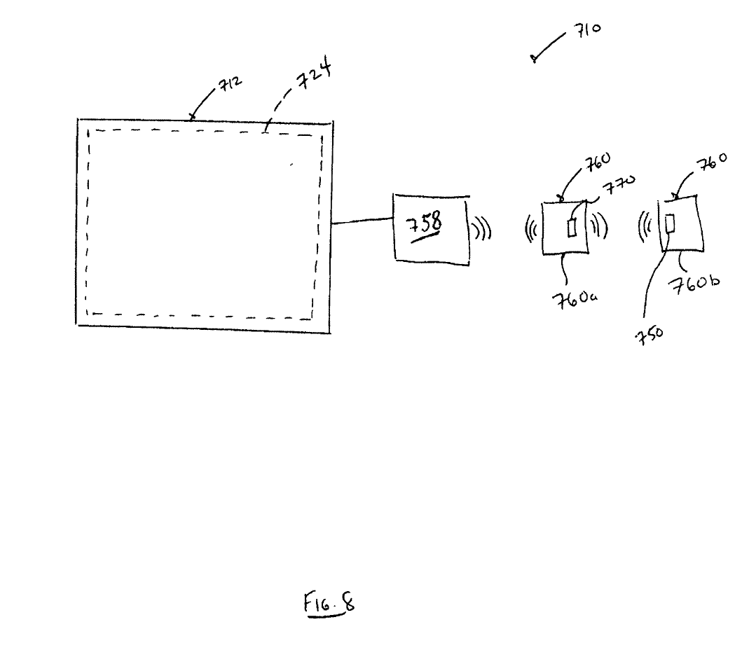

Optionally, one or more of the reception units 660 of the mat system 610 (e.g., the reception unit 660a and/or 660b) functions as a repeater that sends a wireless signal that indicates that the pressure-sensing switch 624 of the mat 612 has been activated to one or more other reception units 660 of the mat system 610. For example, FIG. 8 is a block diagram of another exemplary embodiment of a mat system 710. In the exemplary embodiment, the mat system 710 includes two reception units 760a and 760b and a single pair of a mat 712 and a wired transmission unit 758. The mat system 710 may include any number of reception units 760 and any number of mat 712 and wired transmission unit 758 pairs. The mat 712 may be referred to herein as a “first” and/or a “second” mat. The transmission unit 758 may be referred to herein as a “first” and/or a “second” transmission unit. Each reception unit 760a and 760b may be referred to herein as a “first” and/or a “second” reception unit.

The reception unit 760a is configured to receive a wireless signal from the transmission unit 758 that indicates that a pressure-sensing switch 724 of the mat 712 has been activated. The reception unit 760a is configured to play a selected audio message upon activation of the pressure-sensing switch 724 of the mat 712. Specifically, upon wirelessly receiving the indication that the pressure-sensing switch 724 has been activated, the reception unit 760a plays the corresponding selected audio message (e.g., as is described above with respect to the mat system 10).

The reception unit 760a includes a wireless transmitter 770 configured to transmit a wireless signal indicating that the pressure-sensing switch 724 of the mat 712 has been activated. A wireless receiver 750 of the reception unit 760b is configured to receive the wireless signal from the wireless transmitter 770 of the reception unit 760a that indicates that the pressure-sensing switch 724 of the mat 712 has been activated. The reception unit 760b is configured to play a selected audio message upon activation of the pressure-sensing switch 724 of the mat 712. Specifically, upon wirelessly receiving the indication that the pressure-sensing switch 724 has been activated from the reception unit 760a, the reception unit 760b plays the corresponding selected audio message (e.g., as is described above wish respect to the mat system 10).

The reception unit 760b optionally communicates wirelessly with the transmission unit 758 (e.g., for receiving the wireless signal that the pressure-sensing switch 724 has been activated directly from the transmission unit 758) in addition to the wireless communication with the reception unit 760a. Optionally, the reception unit 760b includes a wireless transmitter (not shown) that sends a wireless signal that indicates that the pressure-sensing switch 724 of the mat 712 has been activated to one or more other reception units 760 of the mat system 710.

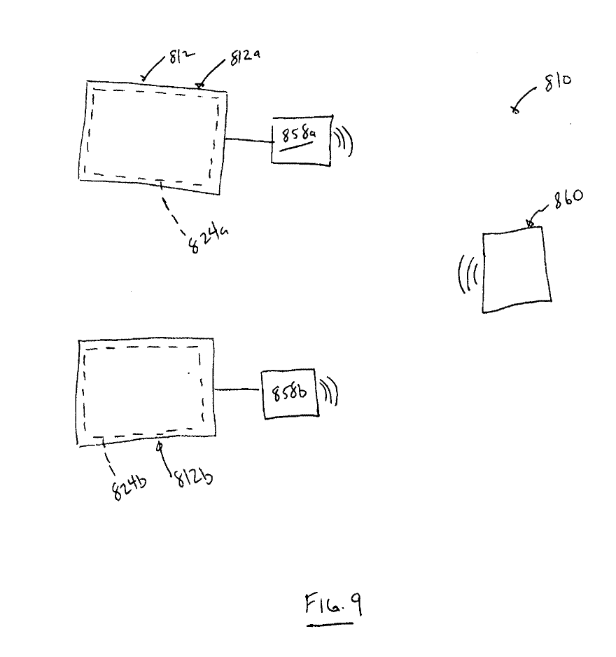

FIG. 9 is a block diagram of another exemplary embodiment of a mat system 810. In the exemplary embodiment, the mat system 810 includes a single reception unit 860, a pair of a mat 812a and a wired transmission unit 858a, and another pair of a mat 812b and a wired transmission unit 858b. The mat system 810 may include any number of reception units 860 and any number of mat 812 and wired transmission unit 858 pairs. Each mat 812a and 812b may be referred to herein as a “first” and/or a “second” mat. Each transmission unit 858a and 858b may be referred to herein as a “first” and/or a “second” transmission unit. The reception unit 860 may be referred to herein as a “first” and/or a “second” reception unit.

The reception unit 860 is configured to receive a wireless signal from the transmission unit 858a that indicates that a pressure sensing switch 824a of the mat 812a has been activated. The reception unit 860 is configured to play a selected audio message upon activation of the pressure-sensing switch 824a of the mat 812a. Specifically, upon wirelessly receiving the indication that the pressure-sensing switch 824a has been activated, the reception unit 860 plays the corresponding selected audio message (e.g., as is described above with respect to the mat system 10).

The reception unit 860 is also configured to receive a wireless signal from the transmission unit 858b that indicates that a pressure-sensing switch 824b of the mat 812b has been activated. The reception unit 860 is configured to play a selected audio message upon activation of the pressure-sensing switch 824b of the mat 812b. Specifically, upon wirelessly receiving the indication that the pressure-sensing switch 824b has been activated, the reception unit 860 plays the corresponding selected audio message (e.g., as is described above with respect to the mat system 10).

Optionally, the reception unit 866 includes one or more selector switches 864 and/or other input devices that enables a user to select between recording an audio message that is associated with the mat 812a and recording an audio message that is associated with the mat 812b. The reception unit 860 optionally includes one or more selector switches and/or other input devices (not shown) that enables a user to select between playing an audio message that is associated with the mat 812a and playing an audio message that is associated with the mat 812b.

The reception unit 860 optionally includes one or more selector switches 872 and/or other input devices that enables a user to selectively disconnect the reception unit 860 from one or both of the mats 812a or 812b such that the reception unit 860 does not play audio upon activation of the respective pressure-sensing switch 824a and 824b of the corresponding mat 812a and/or 812b.

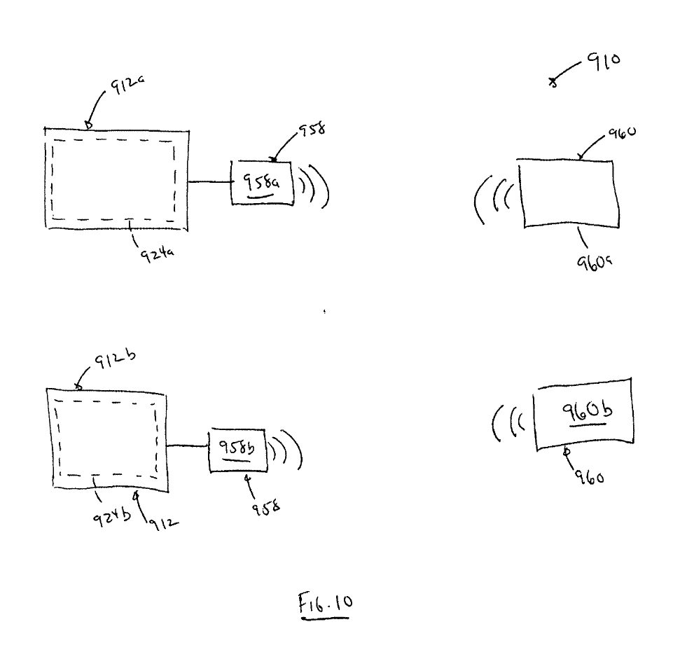

FIG. 10 is a block diagram of another exemplary embodiment of a mat system 910. The mat system 910 includes a plurality of reception units 960 and a plurality of pairs of a mat 912 and a wired transmission unit 958. In the exemplary embodiment, the mat system 910 includes two reception units 960a and 960b, a pair of a mat 912a and a wired transmission unit 958a, and another pair of a mat 912b and a wired transmission unit 958b. The mat system 910 may include any number of reception units 960 and any number of mat 912 and wired transmission unit 958 pairs. Each mat 912a and 912b may be referred to herein as a “first” and/or a “second” mat. Each transmission unit 958a and 958b may be referred to herein as a “first” and/or a “second” transmission unit. Each reception unit 960a and 960b may be referred to herein as a “first” and/or a “second” reception unit.

Each reception unit 960 may be configured to wirelessly communicate with any number of the mats 912 of the mat system 910. In the exemplary embodiment, each reception unit 960 of the mat system 910 is configured to wirelessly communicate with each of the mats 912 (via the associated wired transmission unit 958) of the mat system 910. For example, each reception unit 960a and 960b is configured to receive both: (1) a wireless signal from the transmission unit 958a that indicates that a pressure-sensing switch 924a of the mat 912a has been activated; and (2) a wireless signal from the transmission unit 958b that indicates that a pressure-sensing switch 924b of the mat 912b has been activated. Accordingly, in the exemplary embodiment, each reception unit 960a and 960b is configured to play a selected corresponding audio message upon activation of the pressure-sensing switch 924a of the mat 912a; and each reception, unit 960a and 960b is configured to play a selected corresponding audio message upon activation of the pressure-sensing switch 924b of the mat 912b.

Alternatively, one or more of the reception units 960 of the mat system 910 may be dedicated to a single associated mat 912 of the mat system 910 or to a sub-group (i.e., a group of less than the total number of the mats 912 of the mat system 910) of two or more associated mats 912 of the mat system 910. Specifically, one or more of the reception units 960 of the mat system 910 may only communicate with and/or respond to a single associated mat 912 or a sub-group of associated mats 912 such that the one or more reception units 960 only plays audio when the pressure-sensing switch(es) 924 of the associated mat(s) 912 has been activated.

The mat systems and methods described and/or illustrated herein may be used as a convenient and effective system for indicating when a pet wants to enter or exit an enclosure. The mat systems and/or methods described and/or illustrated herein may be used to train a pet to expel waste (i.e., go the bathroom, relieve themselves, etc.) outside of the dwelling. Moreover, mat systems and/or methods described and/or illustrated herein may be used to train a pet owner about the bathroom and/or other habits of their pet. For example, the method 100 may include using the log module to track the time(s) of day the pet desires to exit and/or enter the enclosure, the frequency at which the pet desires to enter and/or exit the enclosure, a duration that the pet remains applying pressure to the mat, and/or the like. The information tracked by the log module may educate a person as to the waste and/or other habits of their pet, which may enable the pet owner to better plan ahead as to when a person will need to be at the enclosure to allow the pet to enter and/or exit the enclosure. Still further, the mat systems and/or the methods described and/or illustrated herein may be used to provide security to an enclosure, for example by indicating when a person or other individual is positioned outside a barrier to the enclosure.

It should be noted that the various embodiments may be implemented in hardware, software or a combination thereof. The various embodiments and/or components, for example, the modules, or components and controllers therein, also may be implemented as part of one or more computers or processors. The computer or processor may include a computing device, an input device, a display unit and an interface, for example, for accessing the Internet. The computer or processor may include a microprocessor. The microprocessor may be connected to a communication bus. The computer or processor may also include a memory. The memory may include Random Access Memory (RAM) and Read Only Memory (ROM). The computer or processor further may include a storage device, which may be a hard disk drive or a removable storage drive such as a solid state drive, optical drive, and/or the like. The storage device may also be other similar means for loading computer programs or other instructions into the computer or processor.

As used herein, the term “computer” or “module” may include any processor-based or microprocessor-based system including systems using microcontrollers, reduced instruction set computers (RISC), ASICs, logic circuits, and any other circuit or processor capable of executing the functions described herein. The above examples are exemplary only, and are thus not intended to limit in any way the definition and/or meaning of the term “computer”.

The computer or processor executes a set of instructions that are stored in one or more storage elements, in order to process input data. The storage elements may also store data or other information as desired or needed. The storage element may be in the form of an information source or a physical memory element within a processing machine.

The act of instructions may include various commands that instruct the computer or processor as a processing machine to perform specific operations such as the methods and processes of the various embodiments of the invention. The set of instructions may be in the form of a software program. The software may be in various forms such as system software or application software and which may be embodied as a tangible and non-transitory computer readable medium. Further, the software may be in the form of a collection of separate programs or modules, a program module within a larger program or a portion of a program module. The software also may include modular programming in the form of object-oriented programming. The processing of input data by the processing machine may be in response to operator commands, or in response to results of previous processing, or in response to a request made by another processing machine.

As used herein, the terms “software” and “firmware” are interchangeable, and include any computer program stored in memory for execution by a computer, including RAM memory, ROM memory, EPROM memory, EEPROM memory, and non-volatile RAM (NVRAM) memory. The above memory types are exemplary only, and are thus not limning as to the types of memory usable for storage of a computer program.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. Dimensions, types of materials, orientations of the various components, and the number and positions of the various components described herein are intended to define parameters of certain embodiments, and are by no means limiting and are merely exemplary embodiments. Many other embodiments and modifications within the spirit and scope of the claims will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. §112, sixth paragraph, unless and until such claim limitations expressly use the phrase “means for” followed by a statement of function void of further structure.

What is claimed is:

1. A mat system for a pet, the mat system comprising:
a mat comprising a pet side, the mat being configured to be positioned on a ground surface such that the pet side of the mat is exposed for receiving at least, a portion of a pet thereon, the mat comprising a pressure-sensing switch configured to be activated when the pet applies a predetermined amount of pressure to the mat;
a transmission unit operatively connected to the pressure-sensing switch of the mat via a wired connection, the transmission unit comprising:
a first input module configured to accept a first input from a person;
a first playback module operatively connected to the first input module such that the first playback module is configured to play audio that represents the first input, the first playback module being operatively connected to the pressure-sensing switch via the wired connection between the transmission link and the mat, wherein the first playback module is configured to play the audio that represents the first input upon activation of the pressure-sensing switch; and
a wireless transmitter operatively connected to the pressure-sensing switch of the mat, the wireless transmitter being configured to transmit a wireless signal indicating that the pressure-sensing switch has been activated; and
a reception unit comprising:
a wireless receiver configured to receive the wireless signal from the wireless transmitter of the transmission unit;
a second input module configured to accept a second input from a person; and
a second playback module operatively connected to the second-input module such that the second playback module is configured to play audio that represents the second input, the second playback module being operatively connected to the wireless receiver for receiving the indication that the pressure-sensing switch of the mat has been activated, wherein the second playback module is configured to play the audio that represents the second input upon activation of the pressure-sensing switch.

2. The mat system of claim 1, wherein the transmission unit comprises a selector switch operatively connected to the first playback module for selecting between playing the audio that represents the first input and at least one other audio that represents at least one other input accepted by the first input module.

3. The mat system of claim 1, wherein the first playback module is configured to selectively play the audio that represents the first input and at least one other audio that represents at least one other input accepted by the first input module.

4. The mat system of claim 1, wherein the reception unit is a first reception unit and the wireless receiver is a first wireless receiver, the mat system further comprising a second reception unit comprising:
a second wireless receiver configured to receive the wireless signal limit the wireless transmitter of the transmission unit;
a third input module configured to accept a third input from a person; and
a third playback module operatively connected to the third input module such that the third playback module is configured in play audio that represents the third input, the third playback module being operatively connected to the second wireless receiver for receiving the indication that the pressure-sensing switch of the mat has been activated, wherein the third playback module is configured to play the audio that represents the third input upon activation of the pressure-sensing switch.

5. The mat system of claim 1, wherein the wireless transmitter is a first wireless transmitter, the reception unit is a first reception unit, and the wireless receiver is a first wireless receiver, the first reception unit comprising a second wireless transmitter configured to transmit a wireless signal indicating that the pressure-sensing switch of the mat has been activated, the mat system further comprising a second reception unit comprising:
a second wireless receiver configured to receive the wireless signal from the second wireless transmitter of the first reception unit;
a third input module configured to accept a third input from a person; and
a third playback module operatively connected to the third input module such that the third playback module is configured to play audio that represents the third input, the third playback module being operatively connected to the second wireless receiver for receiving the indication that the pressure-sensing switch of the mat has been activated, wherein the third playback module is configured to play the audio that represents the third input upon activation of the pressure-sensing switch.

6. The mat system of claim 1, wherein the mat is a first mat, the pressure-sensing switch is a first pressure-sensing switch, the transmission unit is a first transmission unit, and the wireless transmitter is a first wireless transmitter, the mat system further comprising:
a second mat comprising a pet side, the second mat being configured to be positioned on a ground surface such that the pet side of the second mat is exposed for receiving at least a portion of a pet thereon, the second mat comprising a second pressure-sensing switch configured to be activated when the pet applies a predetermined amount of pressure to the second mat;
a second transmission unit operatively connected to the second pressure-sensing switch of the second mat via a wired connection, the second transmission unit comprising:
a third input module configured to accept a third input from a person;
a third playback module operatively connected to the third input module such that the third playback module is configured to play audio that represents the third input, the third playback module being operatively connected to the second pressure-sensing switch via the wired connection between the second transmission unit and the second mat, wherein the third playback module is configured to play the audio that represents the third input upon activation of the second pressure-sensing switch; and
a second wireless transmitter operatively connected to the second pressure-sensing switch of the second mat, the second wireless transmitter being configured to transmit a wireless signal indicating that the second pressure-sensing switch has been activated; and
wherein the wireless receiver of the reception unit is configured to receive the wireless signal from the second wireless transmitter of the second transmission unit, and wherein the second playback module of the reception unit is configured to, upon activation of the second pressure-sensing switch of the second mat, at least one of play the audio that represents the second input or play at least one other audio that represents at least one other input accepted by the second input models of the reception unit.

7. The mat system of claim 6, wherein the second input is associated with the first mat and the at least one other input is associated with the second mat, the second playback module of the reception unit being configured to play the audio that represents the second input upon activation of the first pressure-sensing switch of the first mat, the second playback module of the reception unit being configured to play the at least one other audio that represents the at least one other input upon activation of the second pressure-sensing switch of the second mat.

8. The mat system of claim 7, wherein the reception unit comprises a selector switch operatively connected to the second input module for selecting between recording the first input and the second input.

9. The mat system of claim 6, wherein the reception unit is a first reception unit and the wireless receiver is a first wireless receiver, the mat system further comprising a second reception unit comprising:
a second wireless receiver configured to receive the wireless signal from the first wireless transmitter of the first transmission unit the second wireless receiver being configured to receive the wireless signal from the second wireless transmitter of the second transmission unit;
a fourth input module configured to accept a fourth input from a person; and
a fourth playback module operatively connected to the fourth input module such that the fourth playback module is configured to play audio that represents the fourth input, the fourth playback module being operatively connected to the second wireless receiver for receiving the indication that the first pressure-sensing switch of the first mat has been activated, wherein the fourth playback module is configured to play the audio that represents the fourth input upon activation of the first pressure-sensing switch, the fourth playback module being operatively connected to the second wireless receiver for receiving the indication that the second pressure-sensing switch of the second mat has been activated, wherein the fourth playback module is configured to, upon activation of the second pressure-sensing switch of the second mat, at least one of play the audio that represents the fourth input or play at least one other audio that represents at least one other input accepted by the fourth input module of the second reception unit.

10. The mat system of claim 1, wherein the mat is a first mat, the pressure-sensing switch is a first pressure-sensing switch, the transmission unit is a first transmission unit, the wireless transmitter is a first wireless transmitter, the reception unit is a first reception unit, and the wireless receiver is a first wireless receiver, the mat system further comprising:
a second mat comprising a pet side, the second mat being configured to be positioned on a ground surface such that the pet side of the second mat is exposed for receiving at least a portion of a pet thereon, the second mat comprising a second pressure-sensing switch configured to be activated when the pet applies a predetermined amount of pressure to the second mat;
a second transmission unit operatively connected to the second pressure-sensing switch of the second mat via a wired connection, the second transmission unit comprising:
a third input module configured to accept a third input from a person;
a third playback module operatively connected to the third input module such that the third playback module is configured to play audio that represents the third input, the third playback module being operatively connected to the second pressure-sensing switch via the wired connection between the second transmission unit and the second mat, wherein the third playback module is configured to play the audio that represents the third input upon activation of the second pressure-sensing switch; and
a second wireless transmitter operatively connected to the second pressure-sensing switch of the second mat, the second wireless transmitter being configured to transmit a wireless signal indicating that the second pressure-sensing switch has been activated; and
a second reception unit comprising:
a second wireless receiver configured to receive the wireless signal from the second wireless transmitter of the second transmission unit;
a fourth input module configured to accept a fourth input from a person; and
a fourth playback module operatively connected to the fourth input module such that the fourth playback module is configured to play audio that represents the fourth input, the fourth playback module being operatively connected to the second wireless receiver for receiving the indication that the second pressure-sensing switch of the second mat has been activated, wherein the fourth playback module is configured to play the audio that represents the fourth input upon activation of the second pressure-sensing switch of the second mat.

11. The mat system of claim 1, wherein the second playback module is configured to selectively play the audio that represents the second input and at least one other audio that represents at least one other input accepted by the second input module.

12. The mat system of claim 1, wherein the reception unit comprises a selector switch operatively connected to the second playback module for selecting between playing the audio that represents the second input and at least one other audio that represents at least one other input accepted by the second input module.

13. The mat system of claim 1, wherein the transmission units is integrated into the mat.

14. The mat system of claim 1, wherein at least one of the first input module or the second input module comprises a microphone and a recording unit.

15. The mat system of claim 1, wherein at least one of the first or the second input module is configured to enable the person to at least one of compose the corresponding first or second input, select the corresponding first or second input from a menu, or select the corresponding first or second input from a list of at least two inputs.

16. A mat system for a pet, the mat system comprising:
a mat comprising a pet side, the mat being configured to be positioned on a ground surface such that the pet side of the mat is exposed for receiving at least a portion of a pet thereon, the mat comprising a pressure-sensing switch configured to be activated when the pet applies a predetermined amount of pressure to the mat;
a transmission unit operatively connected to the pressure-sensing switch of the mat via a wired connection, the transmission unit comprising:
a first input module configured to accept a first input from a person;
a first playback module operatively connected to the first input module such that the first playback module is configured to play audio that represents the first input, the first playback module being operatively connected to the pressure-sensing switch via the wired connection between the transmission unit and the mat, wherein the first playback module is configured to play the audio that represents the first input upon activation of the pressure-sensing switch; and
a wireless transmitter operatively connected to the pressure-sensing switch of the mat, the wireless transmitter being configured to transmit a wireless signal indicating that the pressure-sensing switch has been activated;
a first reception unit comprising:
a first wireless receiver configured to receive the wireless signal from the wireless transmitter of the transmission unit;
a second input module configured to accept a second input from a person; and
a second playback module operatively connected to the second input module such that the second playback module is configured to play audio that represents the second input, the second playback module being operatively connected to the first wireless receiver for receiving the indication that the pressure-sensing switch of the mat has been activated, wherein the second playback module is configured to play the audio that represents the second input upon activation of the pressure-sensing switch; and
a second reception unit comprising:
a second wireless receiver configured to at least one of receive the wireless signal from the wireless transmitter of the transmission unit that indicates that the pressure-sensing switch has been activated or receive a wireless signal that indicates that the pressure-sensing switch has been activated from a second wireless transmitter that is included by the first reception unit;
a third input module configured to accept a third input from a person; and
a third playback module operatively connected to the third input module such that the third playback module is configured to play audio that represents the third input, the third playback module being operatively connected to the second wireless receiver for receiving the indication that the pressure-sensing switch of the mat has been activated, wherein the third playback module is configured to play the audio that represents the third input upon activation of the pressure-sensing switch.

17. A mat system for a pet, the mat system comprising:
a first mat comprising a pet side, the first mat being configured to be positioned on a ground surface such that the pet side of the first mat is exposed for receiving at least a portion of a pet thereon, the first mat comprising a first pressure-sensing switch configured to be activated when the pet applies a predetermined amount of pressure to the first mat;
a first transmission unit operatively connected to the first pressure-sensing switch of the first mat via a wired connection, the first transmission unit comprising:
a first input module configured to accept a first input from a person;
a first playback module operatively connected to the first input module such that the first playback module is configured to play audio that represents the first input, the first playback module being operatively connected to the first pressure-sensing switch via the wired connection between the first transmission unit and the first mat, wherein the first playback module is configured to play the audio that represents the first input upon activation of the first pressure-sensing switch; and
a first wireless transmitter operatively connected to the first pressure-sensing switch of the first mat the first wireless transmitter being configured to transmit a wireless signal indicating that the first pressure-sensing switch has been activated;
a second mat comprising a pet side, the second mat being configured to be positioned on a ground surface such that the pet side of the second mat is exposed for receiving at least a portion of a pet thereon, the second mat comprising a second pressure-sensing switch configured to be activated when the pet applies a predetermined amount of pressure to the second mat;
a second transmission unit operatively connected to the second pressure-sensing switch of the second mat via a wired connection, the second transmission unit comprising:
a second input module configured to accept a second input from a person;
a second playback module operatively connected to the second input module such that the second playback module is configured to play audio that represents the second input, the second playback module being operatively connected to the second pressure-sensing switch via the wired connection between the second transmission unit and the second mat, wherein the second playback module is configured to play the audio that represents the second input upon activation of the second pressure-sensing switch; and
a second wireless transmitter operatively connected to the second pressure-sensing switch of the second mat the second wireless transmitter being configured to transmit a wireless signal indicating that the second pressure-sensing switch has been activated; and
a reception unit comprising:
a wireless receiver configured to receive the wireless signal from the first wireless transmitter of the first transmission unit, the wireless receiver being configured to receive the wireless signal from the second wireless transmitter of the second transmission unit;
a third input module configured to accept a third input from a person; and
a third playback module operatively connected to the third input module such that the third playback module is configured to play audio that represents the third input, the third playback module being operatively connected to the wireless receiver for receiving the indication that the first pressure-sensing switch of the first mat has been activated, wherein the third playback module is configured to play the audio that represents the third input upon activation of the first pressure-sensing switch, the third playback module being operatively connected to the wireless receiver tor receiving the indication that the second pressure-sensing switch of the second mat has been activated, wherein the third playback module is configured to, upon activation of the second pressure-sensing switch of the second mat, at least one of play the audio that represents the third input or play at least one other audio that represents at least one other input accepted by the third input module of the reception unit.

18. The mat system of claim 17, wherein the third input is associated with the first mat and the at least one other input is associated with the second mat, the third playback module of the reception unit being configured to play the audio that represents the third input upon activation of the first pressure-sensing switch of the first mat, the third playback module of the reception unit being configured to play the at least one other audio that represents the at least one other input upon activation of the second pressure-sensing switch of the second mat.

19. The mat system of claim 18, wherein the reception unit comprises a selector switch operatively connected to the third playback module for selecting between playing the audio that represents the third input when the first pressure-sensing switch of the first mat has been activated and playing the at least one other audio that represents the at least one other input when the second pressure-sensing switch of the second mat has been activated

20. The mat system of claim 17, wherein the reception unit comprises a selector switch operatively connected to the third playback module for selectively disconnecting the reception unit from the first or second mat such that the third playback module does not play audio upon activation of the respective first or second pressure-sensing switch of the selected first or second mat.
